(19) United States
(12) Patent Application Publication
(10) Pub. No.: US 2010/0023374 A1
(43) Pub. Date: Jan. 28, 2010

(54) Providing Tailored Messaging to Customers

(75) Inventors: Joshua Berwitz, Upper Saddle River, NJ (US); Gabriel Esparza, Los Angeles, CA (US); Arial Friedman, New York, NY (US); Anthony Mavromatis, Brooklyn, NY (US); Kakul Sinha, Jersey City, NJ (US)

Correspondence Address: Snell & Wilmer L.L.P. (AMEX), ONE ARIZONA CENTER, 400 E. VAN BUREN STREET, PHOENIX, AZ, 85004-2202, US

(73) Assignee: AMERICAN EXPRESS TRAVEL RELATED SERVICES COMPANY, INC., New York, NY (US)

(21) Appl. No.: 12/180,256

(22) Filed: Jul. 25, 2008

(51) Int. Cl. G06Q 30/00

(52) U.S. Cl. 705/10

(57) ABSTRACT

A tailored messaging capability (also referred to as customized messaging) delivers individually relevant or individualized spend recommendations regarding merchants to cardholders at a level of granularity not previously available. This capability brings together the cardholder and the merchant environments to support a spend-centric revenue model. Based on a cardholder's spending history, this tool provides relevant merchant recommendations to the individual cardholder based on that cardholder's unique spend potential in view of that of their peer group. This capability encourages business spend in categories which have historically been paid by invoice, cash, or check. By highlighting relevant merchants, not only is perception of coverage shifted, but specific spend behavior is influenced.

### BACKGROUND

1. Field of the Invention

Embodiments of the present invention relate to marketing, in particular targeted marketing.

2. Related Art

Oftentimes, customers such as small business owners (SBOs) transact with other merchants. Although the customer may be a cardholder of a transactional card associated with a transactional account company, the customer may not use the card for these transactions. The reasoning is twofold. First, the merchant may not accept cards associated with the transactional account company. Second, even if the merchant does accept cards associated with the transactional account company, the customer may not be aware of the merchant's acceptance.

For example, SBOs spend over $2 trillion each year in purchases of “raw materials and inventory” (“RMI”), or materials needed to run their businesses. However, only 12% of that spend occurs using a credit card or other plastic. Rather, the majority of the SBOs pay for their materials using cash or check. Surveys have shown that a significant portion of the SBOs do not think that transactional cards may be used for these purchases, regardless of whether their suppliers actually do allow transactional card purchases. Additionally, surveys have shown that many SBOs would consider using transactional cards for their supplies if they knew the merchant would accept this form of payment, or changing suppliers if a different supplier accepted the transactional card.

Unfortunately, customers may have little way of knowing what cards are accepted by the merchants with whom they transact. Further, it is difficult and time-consuming for customers to locate merchants who fulfill their supply and/or service needs and who also accept their transactional cards.

Therefore, what is needed is a system and method for assisting a customer in locating merchants who accept their transactional cards and who provide the customer with products and services they need.

### BRIEF SUMMARY

Embodiments of the present invention provide individualized merchant recommendations to customers who are cardholders. In an embodiment, a cardholder having spend potential in a given industry is identified. Attributes of merchants used by the cardholder may then be determined, so that merchants in the given industry having attributes similar to the determined attributes may be identified. For example, an identified merchant is a merchant that accepts a particular type of transactional card and that provides the attributes the cardholder requires. Once the merchant has been identified, the cardholder is notified that the merchant accepts the particular type of transactional card.

In an embodiment, a system for providing individualized merchant recommendations to customers who are cardholders includes a potential spend module, a merchant selection module, a message creation module, and a message distribution module. In this embodiment, the potential spend module identifies a cardholder having spend potential in a given industry. The merchant selection module determines attributes of merchants used by the cardholder so that merchants in the given industry having attributes similar to the determined attributes and that accept a particular type of transactional card may be identified. The message creation module prepares a customized message containing an individualized merchant recommendation, and the message distribution module notifies the cardholder of the message.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flowchart of a method for providing individually relevant merchant recommendations to a cardholder according to an embodiment of the present invention.

FIG. 2 is an illustration of a hypothetical industry spend breakdown.

FIG. 3 is a sample of SIC codes that may be considered part of a particular industry.

FIG. 4 is an exemplary merchant recommendation according to an embodiment of the present invention.

FIG. 5 is a flowchart of another method for providing individually relevant merchant recommendations to a cardholder according to an embodiment of the present invention.

FIG. 6 is a diagram illustrating a system for customizing messages to cardholders according to an embodiment of the present invention.

FIG. 7 is a block diagram of an exemplary computer system useful for implementing the present invention.

Embodiments of the present invention will be described with reference to the accompanying drawings. The drawing in which an element first appears is typically indicated by the leftmost digit(s) in the corresponding reference number.

### DETAILED DESCRIPTION

### I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The terms “user,” “end user”, “consumer”, “customer,” “participant,” “cardholder,” “cardmember,” and/or the plural form of these terms are used interchangeably throughout herein to refer to those persons or entities capable of accessing, using, being affected by and/or benefiting from the tool that the present invention provides for providing tailored messaging to consumers.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

### 1. Transaction Accounts and Instrument

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

### 2. Open Versus Closed Cards

“Open cards” are financial transaction cards that are generally accepted at different merchants. Examples of open cards include the American Express®, Visa®, MasterCard and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

### 3. Stored Value Cards

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed. For example, if a customer deposits ten dollars of value into the account associated with the stored value card, the card may only be used for payments together totaling no more than ten dollars.

### 4. Use of Transaction Accounts

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

### II. Tailored Messaging

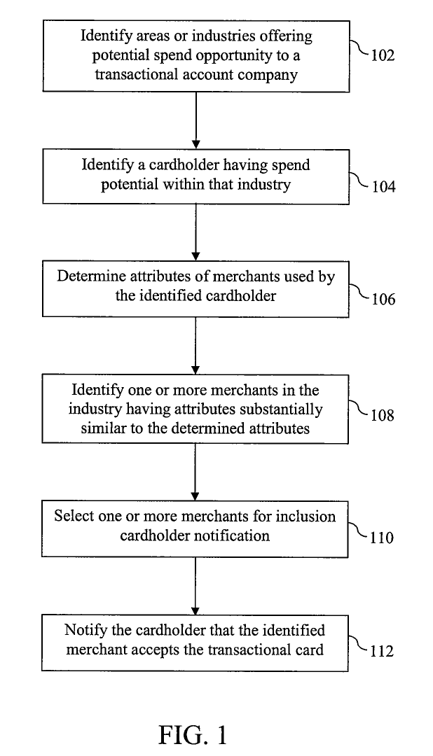

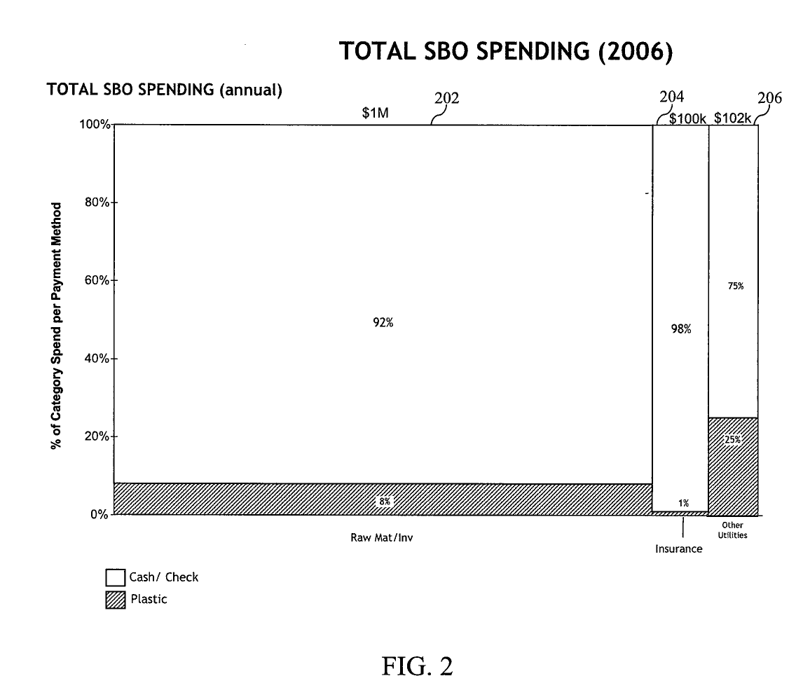

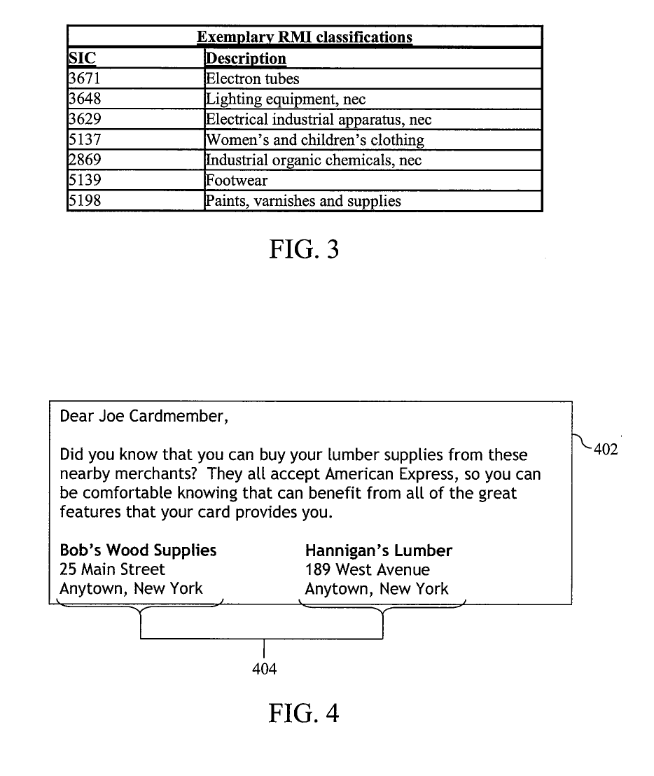

A tailored messaging capability (also referred to herein as customized messaging) delivers individually relevant or individualized merchant recommendations to cardholders at a level of granularity not previously available. This capability brings together the cardholder and the merchant environments to support a spend-centric revenue model. Based on a cardholder's spending history, this tool provides relevant merchant recommendations to the individual cardholder based on that cardholder's unique spend potential in view of that of their peer group. This capability encourages cardholders to spend in categories which have historically been paid by invoice, cash, or check. By highlighting relevant merchants, not only is perception of coverage shifted, but specific spend behavior is influenced. FIG. 1 is a flowchart of an exemplary method for customizing marketing materials to increase spending on particular merchants from a given cardholder. The flowchart includes steps 102-112. Steps 102 and 104 will each be separately discussed at a high level then in detail, including a discussion of FIGS. 2 and 3.

In step 102, in order to determine cardholders to whom the customized materials should be sent, one or more specific areas or industries offering potential opportunity are identified. For example, a transactional account company, such as American Express Co. of New York, N.Y., may determine an industry in which it does not have large market share. To do this, the transactional account company may determine the amount of all spending occurring within a particular industry and determine the percentage of spending within that particular industry that occurs using a transactional card associated with the transactional account company. The amount of spending that occurs using a transactional card will be referred to herein as “plastic” spend. Those industries that have the lowest percentages of plastic spend with the transactional account company compared to total spend represent the industries with the highest opportunities for the transactional account company.

FIG. 2 is an illustration of a hypothetical industry spend breakdown. Each column of FIG. 2 represents a particular industry. For example, column 202 represents the raw materials and inventory (“RMI”) industry, column 204 represents the insurance industry, and column 206 represents an industry including other utilities. The shaded portion of each column represents the percentage of spending in the particular industry that occurs using a transactional card associated with the transactional card company. In the example illustrated, the industry having the greatest portion of customer spending (in this case, $1 million) is the RMI industry, but it is largely unplasticized. That is, only 8% of the spending that occurs in the RMI industry occurs on plastic. In contrast, 92% of spending of the RMI industry occurs using cash or check. For simplicity, embodiments of the present invention will be described as though all plastic spend within an industry occurs with a single transactional account company. However, one of skill in the art will recognize that the plastic spend may occur with multiple transactional account companies, and percentages of each of total spend and plastic spend may be determined and utilized for a specific transactional account company without departing from the spirit and scope of the present invention. As further illustrated in FIG. 2, the insurance industry also represents a significant opportunity in this example, as only 1% of spending within the industry is plastic spend associated with the transactional account company.

Optionally, a transactional account company may also take the consumer's perception of coverage into account when determining opportunity for increased plastic spend. Even if merchants who transact with the cardholders accept transactional cards from a particular company, a cardholder will not use the transactional card if the cardholder does not think the merchant will accept it. As used herein, the “coverage” of a transactional account company refers to the percentage of merchants who accept transactional cards from the company. The “perception of coverage” refers to the percentage of cardholders who think their cards will be accepted by the merchants. Typically, the perception of coverage is less than the actual coverage in industries having significant spend opportunity.

Additional information regarding identifying industries that have opportunities for increased spend may be found in U.S. patent application Ser. No. 11/636,980, filed Dec. 12, 2006, titled, “Identifying Industry Segments with Highest Potential for New Customers or New Spending for Current Customers,” which is incorporated by reference herein in its entirety.

Returning now to FIG. 1, in step 104, once an industry has been identified as having opportunity for increased plastic spend, cardholders having spend potential within that industry are identified. First, cardholders purchasing within a given industry may be identified based on their industry classification or the industry classification of merchants with whom they transact, such as the Standard Industrial Classification (SIC) or the North American Industry Classification System. Multiple industry classifications may correspond to an overall category.

For example, FIG. 3 is a sample of SIC codes that may be considered part of the raw materials and goods industry. The industry classification of a customer may be determined in several ways. If available, the industry classification may be obtained from the transactional account company's internal files. If not available internally, the industry classification may be retrieved from public sources, such as the Securities and Exchange Commission, and/or private sources, such as The Dun & Bradstreet Corporation of Short Hills, N.J.

Once cardholders purchasing within the industry of interest have been identified, cardholders having opportunity for increased plastic spend within that industry may be determined using a customer behavior model. A behavior model is a collection of one or more consumer attributes and correlated effects the attributes have on consumer behavior. Customer behavior models are built in order to understand customer life cycle behavior on an individual customer level. Once the behavior models are built, they may be used to predict customer behavior for individual customers over a given period of time. Attributes may include, for example and without limitation, location, customer profile, historical transactions, customer size of wallet, customer share of wallet, and the like. An example method of determining a size of wallet of a business, as well as a share of wallet of the business, with a particular transactional account company is described in U.S. patent application No. 11/497,563, filed Aug. 2, 2006, titled “Determining Commercial Share of Wallet,” which is incorporated by reference herein in its entirety. An example method of modeling consumer attributes and determining a customer's spend potential in a given industry or category is provided in U.S. patent application Ser. No. 11/608,179, filed Dec. 7, 2006, titled “Industry Size of Wallet,” which is incorporated by reference herein in its entirety.

As described in the '179 application, such a model may be developed, for example, using customers known to spend a high percentage of their available funds with the transactional account company. For example, cardholders who spend between 90% and 98% of their available funds with the transactional account company may be used to build the model. Once the model for identifying cardholders having spend potential within a given category has been developed, such a model may be used to determine the spend potential of a cardholder and identify cardholders who do not spend a high percentage of their available funds within the given category with the transactional account company. Such cardholders are referred to herein as having “spend potential” in the category of interest. The cardholder's current spend in the industry with the transactional account company may also be taken into consideration, and may be calculated based on the cardholder's transaction history.

Returning again to FIG. 1, in step 106 specific attributes of merchants from whom the identified customer has made purchases are determined. These merchants may be determined by reviewing the cardholder's transaction history. For example, where an attribute is an industry classification, industry classifications of merchants included in the cardholder's transaction history may be used. In an embodiment, the top merchant categories by spend are identified for each cardholder. Certain industry classifications may be filtered out. For example, “catch all” or miscellaneous industry classifications may not be considered.

In step 108, merchants who have attributes similar to the attributes determined in step 106 are identified. The merchants may be determined based on, for example, industry classification. In an embodiment, only those merchants who accept cards associated with the transactional account company are considered. In an embodiment, merchants with whom the cardholder already transacts using a particular transactional card are not considered.

In step 110, a subset of the merchants identified in step 108 is selected for inclusion in customized materials to be sent to the cardholder. The subset of merchants may be created by filtering the merchants identified in step 108. In one example, location of both the cardholder and the merchant are considered. For example, merchants near the same location as the cardholder may be included in the subset, while merchants located further from the cardholder are not included. Additionally, or alternatively, the subset may include merchants from a variety of locations to provide the cardholder with a variety of options. Online merchants may be included regardless of location, as they can interact with customers in any location. In another example, merchants may be filtered based on a size of the merchant. In yet another example, merchants may be filtered based on policy and/or legal considerations. For example, merchants who require approval before advertisements are sent may be filtered out. In another example, merchants with whom the cardholder already transacts may be filtered out. In another example, merchants may be filtered based on their locations in force, such that merchants having strong locations in force may be featured more prominently than merchants having minimal locations in force.

In step 112, the customized materials are provided to the cardholder, thereby notifying the cardholder of acceptance by the subset of merchants of a transactional card associated with the transactional account company.

FIG. 4 is an exemplary merchant recommendation notification 402, indicating the merchant subset 404. The notification may be channel agnostic, in that the cardholder may be notified across a variety of channels, including, for example and without limitation, voice, email, and direct mail.

Therefore, using this embodiment of the present invention, shown in FIGS. 1-4, individually relevant or individualized merchant recommendations can be communicated to cardholders in order to drive spend and increase perceptions of coverage. This may also provide a benefit to those merchants accepting transactional cards associated with the transactional account company.

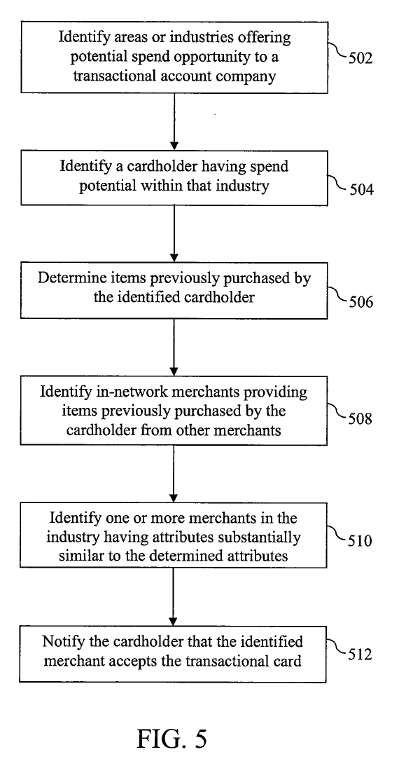

FIG. 5 is another exemplary method for providing individually relevant merchant recommendations to cardholders. Steps 502 and 504 are similar to steps 102 and 104 of FIG. 1.

In step 506, items previously purchased by the cardholder are identified. These items may be determined by reviewing the cardholder's transaction history.

In step 508, merchants providing the items identified in step 506 are determined. In an embodiment, the merchants are determined based on an industry classification of the identified items. In another embodiment, the merchants are identified based on their own transaction histories. In an embodiment, only those merchants who accept cards associated with the transactional account company are considered.

Steps 510 and 512 are similar to steps 110 and 112 of FIG. 1.

### III. System

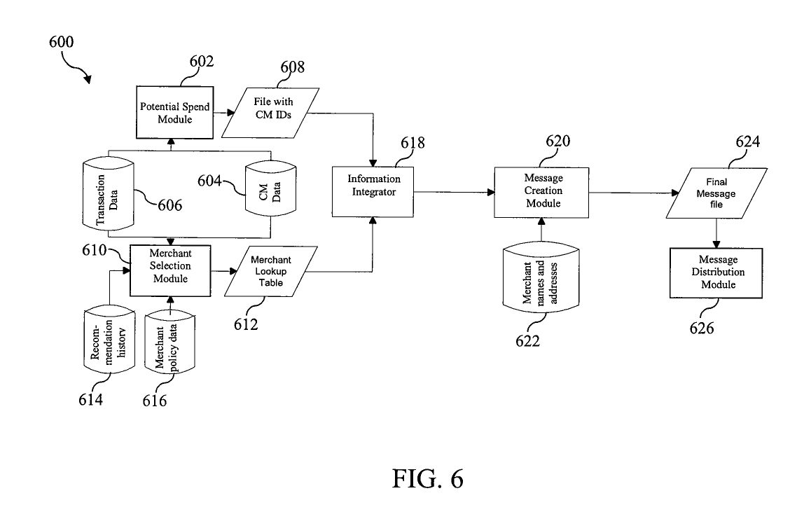

FIG. 6 is a diagram illustrating an exemplary system 600 for customizing messages for cardholders. Components of system 600 may be included in the same physical system, or they may communicate with each other across one or more wired or wireless networks. A potential spend module 602 includes logic that processes received information from a customer database 604 and a transaction database 606 to create a file 608 of customers to receive customized messages. Potential spend module 602 may be used, for example, to perform steps 104 and 504 of FIGS. 1 and 5, respectively.

A merchant selection module 610 includes logic that uses information from customer database 604 and transaction database 606 to create, for example, a merchant lookup table 612. Merchant selection module 610 may also receive information from, for example and without limitation, a recommendation history database 614 and a merchant policy database 616. Merchant policy database 616 may, for example, keep track of those merchants whose contracts have conditions that preclude the merchant name from being used in marketing campaigns. Merchant lookup table 612 is combined with customer file 608 by an information integrator 618 that creates an integrated customer and merchant file. For example, the integrated customer and merchant file may include matched sets of cardholders and merchants. Merchant selection module 610 and information integrator 618 may be used, for example, to perform steps 106-110 of FIG. 1 and steps 506-510 of FIG. 5.

A message creation module 620 combines information from information integrator 618 with information from a merchant name and address database 622 to create a final message file 624. A message distribution module 626 transmits final message file 624 to individual cardholders. Final message file 624 created by message creation module 620 and sent by message distribution module 626 may be similar to that described with respect to FIG. 4. Message creation module 620 and message distribution module 626 may be used, for example, to perform steps 112 and 512 of FIGS. 1 and 5, respectively.

### IV. Example Implementations

Due to the extensive amount of information and processing required to determine which cardholders out of all of a financial transaction company's customers have spend potential and then provide individual merchant recommendations for each cardholder, the process described herein must be at least partially, if not fully, automated. Embodiments of the present invention or any part(s) or function(s) thereof) may be implemented using hardware, software, firmware, or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations.

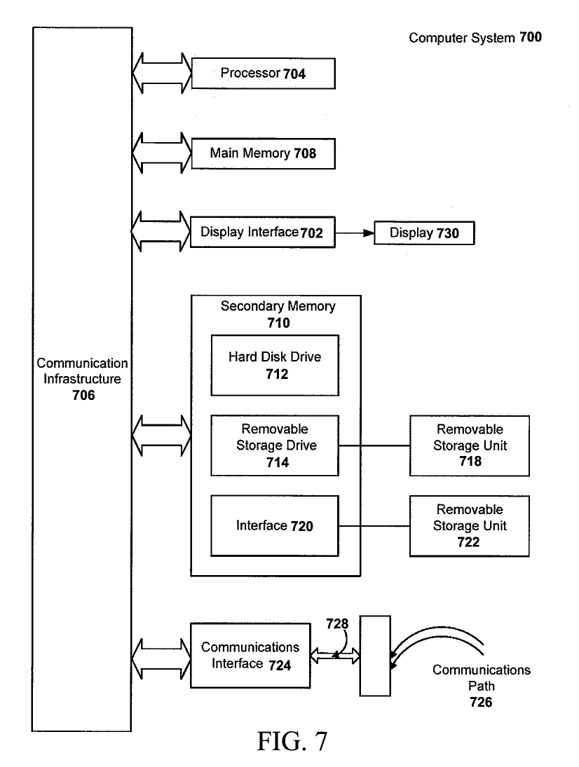

In fact, in one embodiment, the invention is directed toward one or more computer systems capable of carrying out the functionality described herein. An example of a computer system 700 is shown in FIG. 7.

The computer system 700 includes one or more processors, such as processor 704. The processor 704 is connected to a communication infrastructure 706 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 700 can include a display interface 702 that forwards graphics, text, and other data from the communication infrastructure 706 (or from a frame buffer not shown) for display on the display unit 730.

Computer system 700 also includes a main memory 708, preferably random access memory (RAM), and may also include a secondary memory 710. The secondary memory 710 may include, for example, a hard disk drive 712 and/or a removable storage drive 714, representing a floppy disk drive, a magnetic tape drive, an optical disk drive, etc. The removable storage drive 714 reads from and/or writes to a removable storage unit 718 in a well known manner. Removable storage unit 718 represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar devices for allowing computer programs or other instructions to be loaded into computer system 700. Such devices may include, for example, a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728 which may be electronic, electromagnetic, optical or other signals capable of being received by communications interface 724. These signals 728 are provided to communications interface 724 via a communications path (e.g., channel) 726. This channel 726 carries signals 728 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 714 and a hard disk installed in hard disk drive 712. These computer program products provide software to computer system 700. The invention is directed to such computer program products.

Computer programs (also referred to as computer control logic) are stored in main memory 708 and/or secondary memory 710. Computer programs may also be received via communications interface 724. Such computer programs, when executed, enable the computer system 700 to perform the features of the present invention, as discussed herein. In particular, the computer programs, when executed, enable the processor 704 to perform the features of the present invention. Accordingly, such computer programs represent controllers of the computer system 700.

In an embodiment where the invention is implemented using software, the software may be stored in a computer program product and loaded into computer system 700 using removable storage drive 714, hard drive 712 or communications interface 724. The control logic (software), when executed by the processor 704, causes the processor 704 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for communicating an individualized merchant recommendation to a cardholder, comprising:
identifying a cardholder having spend potential in a given industry;
determining attributes of a first set of merchants previously used by the cardholder;
identifying a second set of merchants in the given industry having attributes substantially similar to the determined attributes, wherein each merchant in the second set of merchants accepts a particular type of transactional card; and
notifying the cardholder that each merchant in the second set of merchants accepts the particular type of transactional card.

2. The method of claim 1, wherein at least one merchant in the second set of merchants has not previously been used by the cardholder.

3. The method of claim 1, further comprising prior to the identifying a cardholder:
determining the given industry representing a spend potential for a transactional account company.

4. The method of claim 1, wherein the identifying the cardholder comprises:
determining a total spend of each of a plurality of cardholders within the given industry;
determining a spend potential of each of the plurality of cardholders within the given industry based on the total spend; and
selecting the identified cardholder from the plurality of cardholders having a spend potential above a predetermined threshold.

5. The method of claim 4, wherein the determining the spend potential comprises:
determining an industry share of wallet for each of the plurality of cardholders.

6. The method of claim 1, wherein:
the determining attributes of the first set of merchants includes determining an industry classification of each merchant in the first set of merchants with whom the cardholder transacts; and
the identifying the second set of merchants includes identifying a merchant having the same industry classification.

7. The method of claim 1, wherein:
the determining attributes of the first set of merchants includes determining products sold by merchants with whom the cardholder previously transacted; and
the identifying the second set of merchants includes identifying merchants who sell the same products as the determined products.

8. A system, comprising:
a potential spend module that is configured to identify a cardholder having spend potential in a given industry;
a merchant selection module that is configured to determine attributes of a first set of merchants previously used by the cardholder and identify a second set of merchants in the given industry having attributes substantially similar to the determined attributes, wherein each merchant in the second set of merchants accepts a particular type of transactional card; and
a message distribution module that is configured to notify the cardholder that at least one merchant in the second set of merchants accepts the particular type of transactional card.

9. The system of claim 8, further comprising:
an information integrator that is configured to correlate information about at least one merchant in the second set of merchants with information about the cardholder to generate an integrated customer and merchant file.

10. The system of claim 9, further comprising:
a message creation module that is configured to correlate information from the integrated customer and merchant file with corresponding information accessed from a merchant name and address database to generate a final message.

11. The system of claim 8, wherein the merchant selection module is configured to receive information from at least one of a cardholder transaction database, a cardholder information database, a recommendation history database, and a merchant policy database.

12. The system of claim 8, wherein the merchant selection module is configured to receive industry classification data.

13. The system of claim 8, wherein the message distribution module is configured to output a customized marketing message.

14. A system, comprising:
a processor; and
a memory in communication with the processor, the memory for storing a plurality of processing instructions for directing the processor to:
identify a cardholder having spend potential in a given industry;
determine attributes of a first set of merchants previously used by the cardholder;
identify a second set of merchants in the given industry having attributes substantially similar to the determined attributes, wherein each merchant in the second set of merchants accepts a particular type of transactional card; and
notify the cardholder that each merchant in the second set of merchants accepts the particular type of transactional card.

15. The system of claim 14, wherein at least one merchant in the second set of merchants has not previously been used by the cardholder.

16. The system of claim 14, the memory further storing instructions for directing the processor to:
determine the given industry representing a spend potential for a transactional account company.

17. The system of claim 14, wherein the instructions for directing the processor to identify the cardholder comprise instructions for directing the processor to:
determine a total spend of each of a plurality of cardholders within the given industry;
determine a spend potential of each of the plurality of cardholders within the given industry based on the total spend; and
select the identified cardholder from the plurality of cardholders having a spend potential above a predetermined threshold.

18. The system of claim 17, wherein the instructions for directing the processor to determine a spend potential comprise instructions for directing the processor to:
determine an industry share of wallet for each of the plurality of cardholders.

19. The system of claim 14, wherein:
the instructions for directing the processor to determine attributes of the first set of merchants includes instructions for directing the processor to determine an industry classification of each merchant in the first set of merchants with whom the cardholder transacts; and
the instructions for directing the processor to identify the second set of merchants includes instructions for directing the processor to identify a merchant having the same industry classification.

20. The system of claim 14, wherein:
the instructions for directing the processor to determine attributes of the first set of merchants includes instructions for directing the processor to determine products sold by each merchant in the first set of merchants with whom the cardholder transacts; and
the instructions for directing the processor to identify the second set of merchants includes instructions for directing the processor to identify merchants who sell the same products as the determined products.
